(19) United States
(12) Patent Application Publication
(10) Pub. No.: US 2022/0375006 A1
(43) Pub. Date: Nov. 24, 2022

(54) SYSTEMS AND METHODS FOR CONTROL OF A MINI-GRID

(71) Applicant: Honda Motor Co., Ltd., Tokyo (JP)

(72) Inventor: Boris Hernan Polania Castro, Santa Clara, CA (US)

(21) Appl. No.: 17/326,178

(22) Filed: May 20, 2021

(51) Int. Cl. G06Q 50/06; B60L 53/64; B60L 53/62; G06Q 30/02

(52) U.S. Cl. CPC G06Q 50/06; B60L 53/64; B60L 53/62; G06Q 30/0283

(57) ABSTRACT

A system and method for controlling a mini-grid. In one embodiment, a computer implemented method includes receiving an aggregated demand for a mini-grid from an aggregator based on electrical data. The mini-grid includes a plurality of energy consuming devices and at least one distributed energy resource associated with a user. The method also includes receiving one or more energy pricing schemes from one or more utility providers. The method further includes determining price points for the aggregated demand based on the one or more energy pricing schemes. The method yet further includes generating a usage schedule based on the aggregated demand and the price points. The usage schedule includes a schedule to provide energy to at least one energy consuming device of the plurality of energy consuming devices. The method includes transmitting a notification to the aggregator for the least one energy consuming device based on the usage schedule.

### BACKGROUND

Households currently operate a number of devices that consume energy, and households are increasing operating distributed energy resources (DERs) that are electric generation units (typically in the range of 3 kW to 50 MW) located within the electric distribution system at or near the user. Accordingly, in addition to receiving electricity from one or more utility providers, the user may generate their own electricity. For example, the user may have a number of photovoltaic (PV) cells, or solar cells, convert sunlight directly into electricity.

The user may wish to minimize the amount of electricity purchased from the one or more utility providers in favor of the energy generated by the user's own DERs. However, electricity markets, smart grids, and use of DERs has led to complex electricity market that vary widely in real time. Thus, it is difficult for a user to manage their electricity usage.

### BRIEF DESCRIPTION

According to one aspect, a computer-implemented method for control of a mini-grid is provided. The computer-implemented method includes receiving an aggregated demand for a mini-grid from an aggregator based on electrical data. The mini-grid includes a plurality of energy consuming devices and at least one distributed energy resource. The computer-implemented method also includes receiving one or more energy pricing schemes from one or more utility providers. The computer-implemented method further includes determining price points for the aggregated demand based on the one or more energy pricing schemes. The computer-implemented method yet further includes generating a usage schedule based on the aggregated demand and the price points. The usage schedule includes a schedule to provide energy to at least one energy consuming device of the plurality of energy consuming devices. The computer-implemented method includes transmitting a notification to the aggregator for the least one energy consuming device based on the usage schedule.

According to another aspect, a system for controlling a mini-grid. The system includes a memory storing instructions that when executed by a processor cause the processor to receive an aggregated demand for a mini-grid from an aggregator based on electrical data. The mini-grid includes a plurality of energy consuming devices and at least one distributed energy resource. The plurality of energy consuming devices includes at least one electric vehicle. The instructions also cause the processor to receive one or more energy pricing schemes from one or more utility providers. The instructions further cause the processor to determine price points for the aggregated demand based on the one or more energy pricing schemes. The instructions yet further cause the processor to generate a usage schedule based on the aggregated demand and the price points. The usage schedule includes a schedule to charge the at least one electric vehicle. The instructions cause the processor to transmit a notification to the aggregator for the at least one electric vehicle based on the usage schedule.

According to a further aspect, a computer-implemented method for controlling a mini-grid. The computer-implemented method includes receiving an aggregated demand for a mini-grid from an aggregator based on electrical data. The mini-grid includes a plurality of energy consuming devices and at least one distributed energy resource. The plurality of energy consuming devices includes at least one electric vehicle. The computer-implemented method also includes receiving one or more energy pricing schemes from one or more utility providers. The computer-implemented method further includes determining price points for the aggregated demand based on the one or more energy pricing schemes. The method yet further includes generating a usage schedule based on the aggregated demand and the price points. The usage schedule includes a schedule to charge the at least one electric vehicle. The computer implemented method includes transmitting a notification to the aggregator for the at least one electric vehicle based on the usage schedule.

### BRIEF DESCRIPTION OF THE DRAWINGS

In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a high-level schematic view of an environment for control of a mini-grid, according to an exemplary embodiment.

FIG. 2 is a schematic view of an illustrative electric vehicle architecture that is shown according to an exemplary embodiment.

FIG. 3 is a schematic view of an illustrative original equipment manufacturer central server that is shown according to an exemplary embodiment.

FIG. 4 is a schematic view of a policy application for control of a mini-grid according to an exemplary embodiment.

FIG. 5 is a process flow diagram of a method for control of a mini-grid according to an exemplary embodiment.

FIG. 6 is another process flow diagram of another method for control of a mini-grid according to an exemplary embodiment.

### DETAILED DESCRIPTION

As discussed above, it is difficult for a user to manage their electrical usage given the complex nature of electricity markets and the various entities involved. For example, a user may receive energy from one or more utility providers and also generate their own energy using a number of distributed energy resources (DERs). For example, the user may operate microturbines, small gas combustion turbines, internal combustion engines, fuel cells photovoltaic cells, etc. The DERs may supplement the energy received from the one or more utility providers and/or the user may sell energy back to the one or more utility providers.

The user may also have a number of devices that consume energy, such as an electrical vehicle (EV), household appliances (e.g., refrigerator, oven, stove top, water heater, washer, dryer, dishwasher, air conditioner, etc.), and electronic devices (e.g., computers, laptops, cable box, television, portable device, etc.), among others. The user has the best understanding of their energy needs but may have difficulty balancing the energy usage from the one or more utility providers and the DERs. Furthermore, the energy consuming devices may individually communicate with other entities, such as the one or more utility providers, the original equipment manufacturer (OEM), or a third party.

As one example, electric vehicles (EVs) communicate with a number of different entities including third party electric vehicle infrastructure company and use a number of different communication standards for doing so. For example, Institute of Electrical and Electronics Engineers (IEEE) 2030.5 is a standard for vehicle-to-grid (V2G) communications that handles messaging between the utility and the EV through several intermediate servers. However, currently the IEEE 2030.5 standard has not been widely adopted. The Open Charge Point Protocol (OCPP) is, perhaps, the most adopted communications standard as an extension of existing smart charging (V1G). A more directed V2G protocol is International Organization for Standardization (ISO) 15118 that focuses exclusively in electric vehicle supply equipment (EVSE) communications. Likewise, Deutsches Institut für Normung e.V. (DIN) 70121 is a V2G protocol that focuses exclusively in EVSE-EV communications, but early implementation required modifications.

Transport layer security (TLS) is the public key infrastructure (PKI) for encrypted communications for these communication standards. TLS uses the implementation of Trust Chains. A trust chain is the hierarchy that defines the entity that originates and verifies the encryption certificates. For example, the original manufacturer, electric vehicle infrastructure company, or other third-party may originate and verify the encryption certificates. Some entities develop a framework for considering the issuance of a specific TLS certificate authority at the top of a trust chain. However, this requires existing entities to adopt the new standard, which adds complexity to standards adoption. Accordingly, even if information regarding electrical usage is available, it can be difficult for the user to access that information.

Suppose that an EV is communicating with a third-party electric vehicle infrastructure company. Information flow between the third-party electric vehicle infrastructure company and the EV must go through several security stops, such as to from the third-party electric vehicle infrastructure company to aggregator, aggregator to EVSE, EVSE to EV), to encrypt communications with TLS but not required to be part of the same trust-chain. Therefore, some third-parties may choose to use a different trust chain, this adds complexity to the implementation and makes compliance with a manufacturer's cybersecurity and privacy standards more difficult. Furthermore, third party encrypted channels outside a manufacturer defined trust-chain might create a black communication channel that may have to transport PII information belonging to drivers. EVSE to EV communications can happen outside wired communications through telemetry, this requires some specific TLS configurations that may not be supported by the main communication standards.

Here, a policy application is provided that takes in different information from a mini-grid that includes energy consuming devices and at least one distributed energy resource associated with a user. That information is coordinated to resolve the different protocols. The policy application also determines a usage schedule for the user. The usage schedule may identify when and how to charge the energy consuming devices based on the utility providers and the DERs. Suppose that a utility provider offers a pricing scheme for reduced rates during different timeframes of the day. For example, the charging policy application may determine a charging demand for charging an EV at one or more timeframes based on the aggregated demand of the other energy consuming devices. Moreover, the aggregator may prevent malicious attacks in the system.

### Definitions

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Local Interconnect Network (LIN), among others.

“Charging station,” as used here, refers to an access point to an energy source that a vehicle can engage to receive a charge. Accordingly, the charging station is an element in an energy infrastructure capable of transferring energy, for example, from the grid to a vehicle. The charging station may include a connector to connect to the vehicle to the charging station. For example, the charge connector may include a range of heavy duty or special connectors that conform to the variety of standards, such as DC rapid charging, multi-standard chargers, and AC fast charging, etc.

“Computer communication,” as used herein, refers to a communication between two or more computing devices (e.g., computer, personal digital assistant, cellular telephone, network device, vehicle, vehicle computing device, infrastructure device, roadside equipment) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication can utilize any type of wired, wireless, or network communication protocol including, but not limited to, Ethernet (e.g., IEEE 802.3), WIFI (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface,” as used herein can include input and/or output devices for receiving input and/or devices for outputting data. The input and/or output can be for controlling different vehicle features, which include various vehicle components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface, which can be displayed by various types of mechanisms such as software and hardware-based controls, interfaces, touch screens, touch pads or plug and play devices. An “output device” includes, but is not limited to, display devices, and other devices for outputting information and functions.

A “computer-readable medium”, as used herein, refers to a medium that provides signals, instructions, and/or data. A computer-readable medium may take forms, including, but not limited to, non-volatile media and volatile media. Non-volatile media may include, for example, optical or magnetic disks, and so on. Volatile media may include, for example, semiconductor memories, dynamic memory, and so on. Common forms of a computer-readable medium include, but are not limited to, a floppy disk, a flexible disk, a hard disk, a magnetic tape, other magnetic medium, other optical medium, a RAM (random access memory), a ROM (read only memory), and other media from which a computer, a processor or other electronic device may read.

A “data store”, as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device. The data store can also refer to a database, for example, a table, a set of tables, a set of data stores (e.g., a disk, a memory, a table, a file, a list, a queue, a heap, a register) and methods for accessing and/or manipulating those data in those tables and data stores. The data store can reside in one logical and/or physical entity and/or may be distributed between two or more logical and/or physical entities.

An “electric vehicle” (EV), as used herein, refers to any moving vehicle that is capable of carrying one or more human occupants and is powered entirely or partially by one or more electric motors powered by an electric battery. The EV may include battery electric vehicles (BEVs), plug-in hybrid electric vehicles (PHEVs) and extended range electric vehicles (EREVs). The term “vehicle” includes, but is not limited to: cars, trucks, vans, minivans, SUVs, motorcycles, scooters, boats, personal watercraft, and aircraft. The term “vehicle” can also refer to an autonomous vehicle and/or self-driving vehicle. Further, the term “vehicle” can include vehicles that are automated or non-automated with pre-determined paths or free-moving vehicles.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discreet logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

An “operable connection”, or a connection by which entities are “operably connected”, is one in which signals, physical communications, and/or logical communications can be sent and/or received. An operable connection can include a physical interface, a data interface and/or an electrical interface.

A “portable device”, as used herein, is a computing device typically having a display screen with user input (e.g., touch, keyboard) and a processor for computing. Portable devices include, but are not limited to, key fobs, handheld devices, mobile devices, smart phones, laptops, tablets and e-readers.

A “processor”, as used herein, processes signals and performs general computing and arithmetic functions. Signals processed by the processor can include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “user,” as used herein can include, but is not limited to, one or more biological beings exerting a demand on a source of energy, such as an electrical grid. The demand on the source of energy may be exerted through an energy consuming device and/or a DER. A user may be associated with a household, building, office, and/or EV.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview

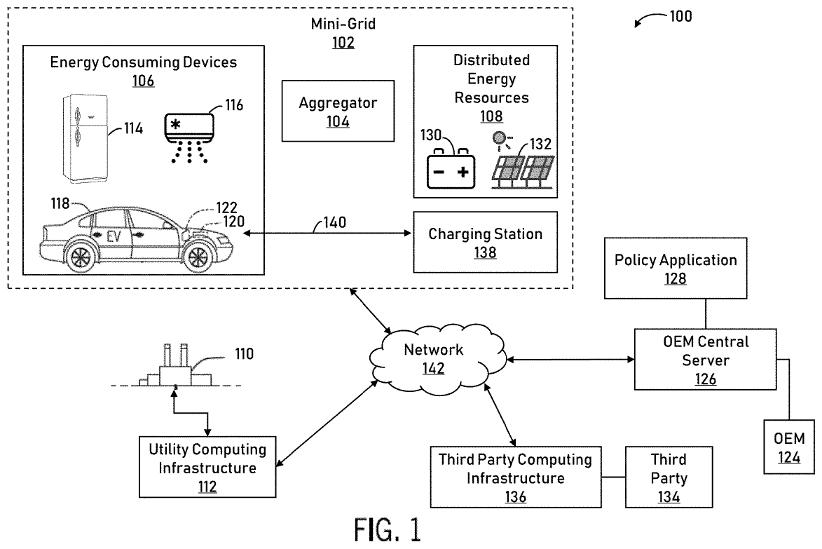

Referring now to the drawings, wherein the showings are for purposes of illustrating one or more exemplary embodiments and not for purposes of limiting same, FIG. 1 is a high-level schematic view of an environment 100 for controlling a mini-grid 102 according to an exemplary embodiment. The components of the environment 100, as well as the components of other systems and architectures discussed herein, may be combined, omitted or organized into different architectures for various embodiments.

In the exemplary embodiment of FIG. 1, the environment 100 includes the mini-grid 102 having an aggregator 104, a plurality of energy consuming devices 106, and at least one distributed energy resource (DER) 108 associated with a user. The mini-grid may be associated with a household, residential unit, office, business of the user. In some embodiments, the mini-grid 102 is associated with premises identified by a utility provider 110. For example, the mini-grid 102 may be accessed by a utility computing infrastructure 112 of the utility provider 110. The utility computing infrastructure 112 may include an electrical meter that measure the amount of electrical energy consumed at the premises. In this manner, the mini-grid 102 captures the energy usage of the plurality of energy consuming devices 106 and the energy generation of the DERs 108.

The energy consuming devices 106 may include a first energy consuming device 114, a second energy consuming device 116, and one or more electric vehicles (EVs) 118. The first energy consuming device 114 and the second energy consuming device 116 consume energy, and may be a household appliance (e.g., refrigerator, oven, stove top, water heater, washer, dryer, dishwasher, air conditioner, etc.), or electronic device (e.g., computers, laptops, cable box, television, portable device, etc.), among others. The EV(s) 118 may be powered by an electric motor 120 and an electric storage mechanism, for example, a battery 122. In one embodiment, the EV(s) 118 may be purely electric in that it only has the electric motor 120 and the battery 122. In other embodiments, the EV(s) 118 may have the electric motor 120, the battery 122, and an internal combustion engine (not shown). In some embodiments, the EV(s) 118 may have any number of electric motors, batteries, and/or internal combustion engines and they may operate in series (e.g., as in an extended range electric vehicle), in parallel, or some combination of series and parallel operation.

The EV(s) 118 that may be manufactured, owned, and/or operated by the one or more original equipment manufacturers (OEMs) 124 or a user (not shown). In one embodiment, the environment 100 may additionally include an OEM central server 126 that may be accessed and utilized by one or more OEMs 124 (e.g., EV manufacturers). As discussed below, the OEM central server 126 may include a computing device (shown in FIG. 3) that is configured to execute a policy application 128. The policy application 128 may be configured to communicate with one or more utility providers 110 to receive one or more energy pricing schemes. For example, the energy pricing schemes may include different rate structures such as simple, tiered, time of use (TOU), demand rates, tiered within TOU, seasonal rates, holiday rates, etc. Simple (i.e., fixed) energy pricing schemes offer users a flat rate per kWh. Tiered (i.e., step) energy pricing schemes include rate changes based on the amount of use. For example, some go up to encourage energy conservation while others go down to encourage use. In a TOU energy pricing scheme, the rate is based on the time of day. Tiered within TOU energy pricing schemes offer different rates depending use at a specific time of day. Demand energy pricing schemes include rated based on peak usage. Seasonal and holiday energy pricing schemes offer different rates based on when the premises are used. For example, a cottage that is only used in the summer months may have different rates in the summer as opposed to the winter months.

To supplement the energy received from the one or more utility providers 110 and offset the cost of buying energy, the mini-grid 102 may include DERs 108 to generate energy for the energy consuming devices 106 of the mini-grid 102. The DERs 108 may include a first generation resource 130 and a second generation resource 132. The first generation resource 130 and the second generation resource 132 may be microturbines, small gas combustion turbines, internal combustion engines, fuel cells, battery cells, or photovoltaic cells, among others. Accordingly, the DERs provide additional energy to the mini-grid 102 in addition to the energy received from the utility provider 110 via the utility computing infrastructure 112.

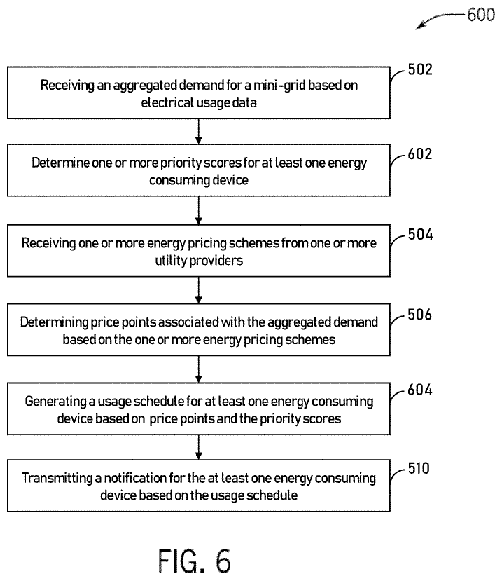

The aggregator 104 groups electrical data for the plurality of energy consuming devices 106, the at least one DER 108, and/or a charging station 138 associated with the user. The electrical data may include information from or about the energy consuming devices 106 and the DERs 108 such as type of device, power (Watts or kilowatts (kW)), average usage (hours per day), consumption (kilowatt hours (kWh) per day), load patterns, state of charge data, charge parameters, charging data and feedback, vehicle system data, historical usage data, operating and/or charging schedules, etc. The electrical data may also include a priority score as will be discussed with regard to FIG. 6.

By grouping all the distinct devices of the plurality of energy consuming devices 106 and/or the at least one DER 108 in the mini-grid 102, the aggregator 104 allows the mini-grid 102 to calculate an aggregated demand. The aggregated demand is a measure of how much electricity the mini-grid requires at a given point in time, and may be measured in kW. The aggregated demand may additionally or alternatively be the average rate at which the mini-grid 102 consumes electricity in a defined time interval and be measured in kWh. The aggregator 104 may calculate the aggregated demand based on the electrical data of the distinct devices of the energy consuming devices 106 and the DERs 108 in the mini-grid 102. In another embodiment, the aggregated demand may be a subset of electrical data from the electrical data received from or about the distinct devices of the mini-grid 102.

The aggregator 104 allows the mini-grid to act as a utility, like the one or more utility providers 110. In particular, the aggregator 104 is an intermediary between the user and power system participants, such as the one or more utility providers 110 and the OEM 124, as well additional participants, like a third party 134. For example, the third party 134 may utilize third party computing infrastructure 136 to serve the user or exploit the services provided by the DERs 108 of the mini-grid 102.

The policy application 128 is configured to determine price points for the aggregated demand based on the one or more energy pricing schemes. The policy application 128 may additionally be configured to evaluate the one or more energy pricing schemes to determine a plurality of price points. For example, the price points may be associated with demand response events of the EV(s) 118 that are based on state of charge (SOC) data that pertains to the state of charge of the EV(s) that are communicated to the OEM 124. The policy application 128 may determine the aggregated demand based on the electrical data received from the aggregator 104. The policy application 128 may additionally process an OEM charging policy option. The OEM charging policy option may include an agreement that may be accepted by the one or more utility providers 110 in order for the OEM 124 to modify a pricing scheme. In particular, if the OEM charging policy option is accepted (i.e., electronically accepted) by the one or more utility provider(s) 110, the OEM charging policy option may be utilized by the OEM 124 to modify the pricing scheme based on electrical data so that the pricing scheme is tailored to the demand of the mini-grid 102.

As explained in more detail below, in one embodiment, the usage schedule(s) may alter the charging pattern of the energy consuming devices 106 such as the EV(s) 118 to charge the EV(s) 118 at one or more timeframes that include a low cost for a user. In other words, based on the acceptance of the OEM charging policy option by the utility provider(s) 110, the usage schedule may be modified such that the EV(s) 118 may be scheduled to be charged during a period(s) of time that includes a low cost or allow the user to take advantage of the energy generation of the DERs 108.

In one embodiment, as discussed below, the policy application 128 may additionally facilitate the payment of one or more incentive fees from the one or more utility providers 110 to the user and/or the one or more OEMs 124 based on a usage schedule. The incentive fee may be paid as a remittance to the user and/or the OEM 124 to modify the usage schedule(s) in such a manner that lowers the utility provider cost to produce energy to keep up with demand response events. The policy application 128 may also facilitate the compensation of the user.

The policy application 128 communicates with the aggregator 104 to allow the user to maximize control over the consumption of the mini-grid 102. For example, the policy application 128 may facilitate charging of the EV(s) 118 to cause the EV(s) 118 to receive a charge from a charging station 138 in the mini-grid 102 at a lower price point with respect to a cost to purchase energy.

In the exemplary embodiment, the environment 100 includes electric vehicle supply equipment (EVSE), such as the one or more charging stations 138 and a charging link(s) 140 that connects the charging station(s) 138 to the EV(s) 118. The EVSE may each include separate computing devices(s) (not shown) that may process and execute electronic processes. In one or more embodiments, the charging station(s) 138 may include charging equipment and may be installed at a residential home or outside a residential home, for example, at a public or private charging station. The charging station(s) 138 replenishes the battery 122 of the EV(s) 118 using a charging energy source type that indicates the type of energy the charging station provides that may be generated and/or supplied by the utility provider(s) 110.

In one or more embodiments, the charging station(s) 138 may receive energy from the utility provider(s) 110 to replenish one or more electric storage mechanisms (e.g., the battery 122) of the EV 118 by charging the EV 118 through the charging link(s) 140. Additionally, in some embodiments, the charging station(s) 138 may be operably connected for computer communication with the EV(s) 118 and/or the OEM central server 126, for example, to transmit and receive the electrical data.

The charging link(s) 140 may be a wired or wireless link to the charging station(s) 138. Computer communication may occur also via the charging link(s) 140 and/or a wired or wireless communication link. In one embodiment, the EV(s) 118, the charging station(s) 138 and/or the charging link(s) 140 may be operably controlled to initiate or terminate charging of the EV(s) 118 from the charging station(s) 138 based on one or more charging schedules that are created by the policy application 128. Accordingly, if the policy application 128 modifies the demand-based charging schedule based on the acceptance of the OEM charging policy option, the EV(s) 118, the charging station(s) 138, and/or the charging link(s) 140 may be operably controlled to initiate or terminate charging according to the usage schedule.

In one embodiment, the EV(s) 118, the charging station(s) 138, and/or the charging link(s) 140 may be configured to wirelessly communicate a respective state of charge (SOC) (e.g., battery charge remaining) of the EV(s) 118 at one or more points in time. The charging station(s) 138 and/or the charging link(s) 140 may also wirelessly communicate charging information that may indicate the utilization of the charging station(s) 138 and/or the charging link(s) 140 at one or more points in time. Such data may be communicated through a network 142 in the form of SOC data and charging data to the OEM central server 126. The network 142 serves as a communication medium for the power system participants (e.g. mini-grid 102, the one or more utility providers 110, the OEM 124, and the third party 134, as well as various remote devices (e.g., databases, web servers, remote servers, application servers, intermediary servers, client machines, other portable devices).

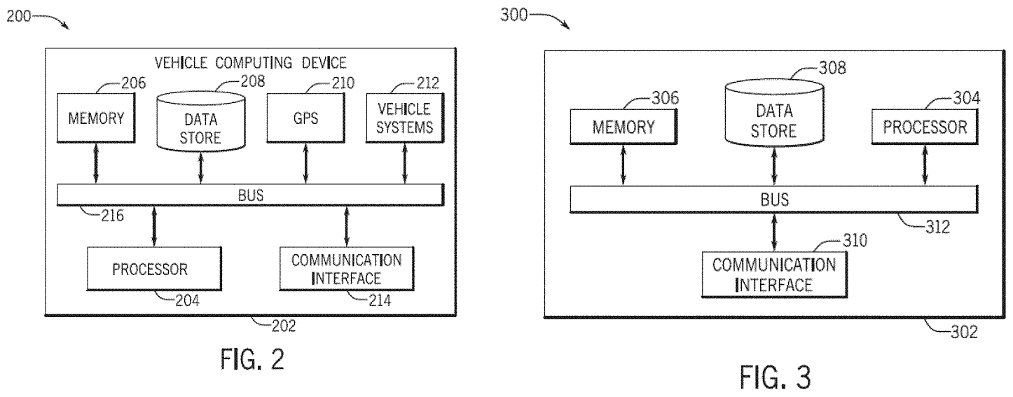

Referring now to FIG. 2, a schematic view of an illustrative electric vehicle architecture 200, for example the EV(s) 118 of FIG. 1, is shown according to an exemplary embodiment. In particular, the EV(s) 118 may include a vehicle computing device 202 (e.g., a telematics unit, an electronic control unit) with provisions for processing, communicating and interacting with various components of the EV(s) 118 and other components of the environment 100. The vehicle computing device 202 may include a processor 204, a memory 206, a data store 208, a position determination device 210 (GPS), a plurality of vehicle systems 212 (e.g., including the electric motor 120, the battery 122) and a communication interface 214. The components of the architecture 200, including the vehicle computing device 202, may be operably connected for computer communication via a bus 216 (e.g., a Controller Area Network (CAN) or a Local Interconnect Network (LIN) protocol bus) and/or other wired and wireless technologies. The vehicle computing device 202 as well as the EV(s) 118 may include other components and systems not shown.

In some embodiments, the data store 208 may store application data that may also include data pertaining to the policy application 128. The communication interface 214 of the EV 118 may provide software, firmware and/or hardware to facilitate data input and output between the components of the vehicle computing device 202 and other components, networks and data sources. Further, the communication interface 214 may facilitate communication between the EV(s) 118 and the OEM central server 126 to thereby send and receive data to and from the OEM central server 126. Such data may include the SOC data sent from the EV(s) 118 to the OEM central server 126 and/or vehicle update data sent from a respective OEM 124 to the EV(s) 118. In alternate embodiments, the communication interface 214 may also facilitate communication between the EV(s) 118 and a utility computing infrastructure 112 and/or a third-party computing infrastructure 136 (shown in FIG. 1) to communicate data to and receive data from the respective infrastructures 112, 136.

Referring now to FIG. 3, a schematic view of an illustrative OEM central server architecture 300, for example, OEM central server 126 of FIG. 1, is shown according to an exemplary embodiment. The OEM central server 126 may be accessed by one or more OEMs 124 to be utilized to process and store the electrical data that may include vehicle data, vehicle specifications, pricing data, and/or additional data that may be utilized to process one or more pricing schemes and/or OEM charging policy options. As shown, the OEM central server 126 may include a computing device 302 that may further include a processor 304, a memory 306, a data store 308, and a communication interface 310. The components of the architecture 300, including the computing device 302, may be operably connected for computer communication via a bus 312 and/or other wired and wireless technologies.

The data store 308 may store application data that may also include data pertaining to the policy application 128. The communication interface 310 may be configured to provide software, firmware, and/or hardware to facilitate data input and output between the components of the computing device 302 and other components, networks and data sources. In one or more embodiments, the communication interface 310 may be used to communicate with the OEM 124 to send and receive data between one or more OEMs 124 and/or to one or more OEMs 124 from the OEM central server 126. The communication interface 310 may also be configured to communicate with the EV(s) 118, the charging station(s) 138, the charging link(s) 140, the utility computing infrastructure 112, the third-party computing infrastructure 136, and/or other components of environment 100 to determine an aggregated demand, evaluate pricing schemes, communicate the OEM charging policy option, and facilitate payment of one or more incentive fees.

Referring again to FIG. 1, with particular reference to the utility computing infrastructure 112, the utility computing infrastructure 112 may include one or more computing devices (not shown, similar to the computing device 302) that may communicate with one or more utility providers 110 that may include a facility for generating, transmitting and/or distributing energy to users, including, but not limited to, the charging station(s) 138. In one embodiment, the utility computing infrastructure 112 may receive perspective and/or real-time price data that may be provided by each respective utility provider 110 to communicate rates associated with the cost to produce energy (e.g., costs associated with the generation of power) at one or more periods of time.

The real-time price data may include costs to produce energy for one or more utility providers 110 that may be communicated by the utility provider(s) 110 to the utility computing infrastructure 112. Upon the receipt of the real-time price data, the utility computing infrastructure 112 may be configured to aggregate the respective costs that may be associated with the utility provider(s) 110 to produce energy at one or more periods of time to determine one or more energy pricing schemes. The pricing schemes may pertain to a plurality of price points associated with costs to produce energy that may be associated with levels of charging demands that may occur or may be predicted to occur at various timeframes.

The plurality of price points may indicate a cost for the utility providers (a price per kilowatt-hour of energy (price per kWh)) that may be charged at various timeframes with respect to a cost to produce energy for the one or more utility providers 110. The cost to produce energy may include a dynamic value that may change over time based on a time of day, a season, a region, a time zone, etc. For example, each hour of a particular day may include a different cost to produce energy based on one or more pricing schemes that are implemented by one or more natural resource providers, utility providers, and one or more levels of charging demands that may be influenced by the charging schedules implemented by the OEM 124 among other factors (e.g., high expected traffic flow timeframes).

In an exemplary embodiment, as discussed below, the OEM 124 may utilize the policy application 128 to process the pricing schemes to determine a distribution of price points within a predetermined period of time. For example, the one or more points in time in which the cost to purchase energy may include times in which the cost to purchase energy is within a lowest 5% of a distribution of price points to purchase energy during a twenty-four hour period. As discussed below, the one or more pricing schemes and/or OEM charging policy option may be processed by the policy application 128 based on the electronic processing completed by the components of the OEM central server 126 and communication of the OEM charging policy option from the OEM central server 126 to the utility computing infrastructure 120.

In an additional embodiment, the utility provider(s) 110 may communicate an incentive pricing scheme that is stored on the utility computing infrastructure 112 and may be communicated to the OEM central server 126 to thereby provide an incentive to the OEM 124 to modify one or more demand based charging schedules to charge the EV(s) 118 at one or more timeframes that may result in the lowering of the cost to produce energy to keep up with the charging schedule demand. Accordingly, the incentive scheme may be analyzed by the policy application 128 to determine one or more monetary incentives that may be provided (paid) to the user or the OEM 124 based on the modification of the usage schedule(s) to lower the charging demand and the price point for the utility provider(s) 110.

In an exemplary embodiment, the third-party computing infrastructure 136 may include one or more computing devices (not shown, similar to the computing device 302) that may communicate to one or more third parties 134. The one or more timeframes at which a low carbon footprint may be determined based on a measure of average emissions caused by the production of energy at one or more timeframes, an overall usage of electricity at one or more timeframes, traffic patterns at one or more timeframes, and other energy usage at one or more timeframes. The carbon credit payments may provide an incentive for the users to purcahse power at one or more timeframes at which the carbon footprint may be low.

### II. Application and Related Methods

The policy application 128 and its components will now be discussed in more detail according to an exemplary embodiment, and with continued reference to FIGS. 1-3. In one or more embodiments, the policy application 128 may be executed by the computing device 302 of the OEM central server 126. In additional embodiments, the policy application 128 may be executed by the vehicle computing device 202 of the EV(s) 118. Data may be sent or received from the policy application 128 to/from components of the OEM central server 126, the EV(s) 118, the charging station(s) 138, the charging link(s) 140, the utility computing infrastructure 112, and/or the third-party computing infrastructure 136. As discussed below, the policy application 128 may include various modules and/or logic to facilitate the processing and implementation of the OEM charging policy option.

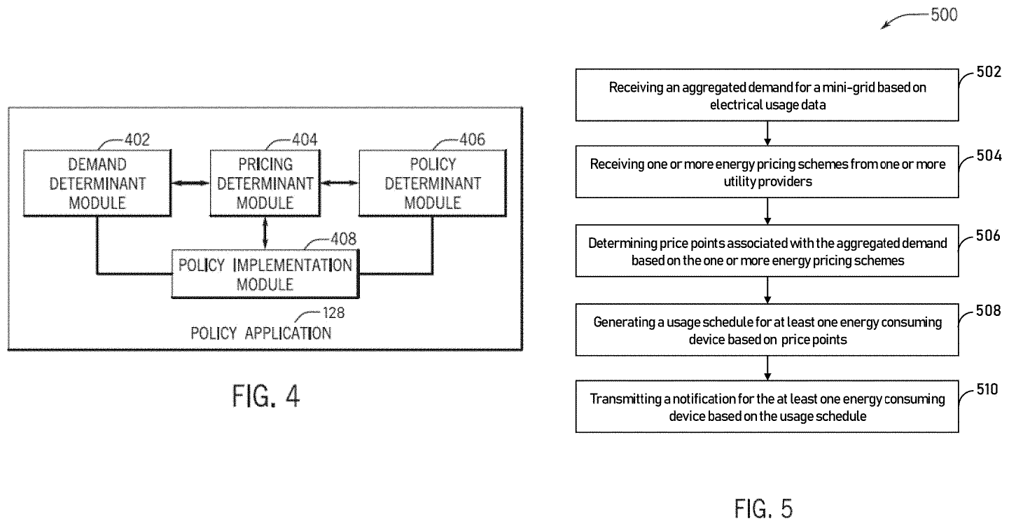

Referring to FIG. 4, a schematic view of the policy application 128 that is shown according to an exemplary embodiment of the present disclosure, the policy application 128 may include a demand determinant module 402, a pricing determinant module 404, a policy determinant module 406, and a policy implementation module 408. As described in more detail below, the modules 402-408 may execute computer implemented processes that may be utilized to control the mini-grid 102 according to a usage schedule.

FIG. 5 is a process flow diagram of a method 500 for determining one or more demand based charging schedules and determining price points associated with charging demands according to an exemplary embodiment. FIG. 5 will be described with reference to the components of FIGS. 1-4, though it is to be appreciated that the method 500 of FIG. 5 may be used with other system and/or components.

At block 502, the method 500 includes receiving an aggregated demand for a mini-grid 102 from an aggregator 104 based on electrical data. In one embodiment, the demand determinant module 402 of the policy application 128 may be configured to utilize the communication interface 310 of the OEM central server 126 to communicate with one or more of the plurality of sources that may provide the electrical data, such as the aggregator 104.

For example, the aggregated demand may include a current electrical demand from the plurality of energy consuming devices 106 offset by the energy generated by at least one device of the DERs 108. Accordingly, the aggregated demand may be based on electrical data such as usage, consumption, and generation of device in the mini-grid 102. In another embodiment, the aggregated demand may an estimate of electrical demand at a future point in time. Therefore, the aggregated demand may be based on energy modeling, historical data, and/or type of device for the plurality of energy consuming devices 106 and the DERs 108, among others. The aggregated demand may be a single value. The value may be in kW or kWh. In another embodiment, the aggregated demand may be electrical data regarding one or more of the devices of the mini-grid 102. The aggregated demand for charging may indicate one or more timeframes at which there are one or more demand levels (e.g., low, medium, high) for one or more of the plurality of energy consuming devices 106 and/or the DERs 108

In one embodiment, the electrical data may include SOC data for the EV(s) 118 and be received by the OEM central server 126 directly from the EV(s) 118 based on wireless communication between the communication interface 214 of the vehicle computing device 202 of the EV(s) 118 and the communication interface 310 of the computing device 302 of the OEM central server 126. The OEM central server 126 may accordingly obtain real-time SOC data associated with the EV(s) 118 at one or more points in time that may be further analyzed by the policy application 128 and/or accessed by the OEM(s) 124.

In one embodiment, electrical data may also be received by the OEM central server 126 through communications by the charging station(s) 138 and/or the charging link(s) 140 based on the utilization of the charging station(s) 138 and/or the charging link(s) 140 to charge the EV(s) 118. Such charging data may indicate the utilization of the charging station(s) 138 and/or the charging link(s) 140 at one or more points in time. The OEM central server 126 may accordingly obtain the charging data communicated by the charging station(s) 138 and/or the charging link(s) 140 at one or more points in time that may be further analyzed by the policy application 128 and/or accessed by the OEM(s) 124.

At block 504, the method 500 includes receiving one or more energy pricing schemes from one or more utility providers. In an exemplary embodiment, receiving the aggregated demand, the demand determinant module 402 may communicate respective data to the pricing determinant module 404 of the policy application 128. The policy application 128 may thereby utilize the communication interface 310 of the OEM central server 126 to communicate data pertaining to the one or more pricing schemes to the utility computing infrastructure 112 to be evaluated by the one or more utility providers 110.

In one embodiment, the one or more energy pricing schemes may include pricing categories (e.g., price ranges, price average overage percentage) that may be charged to the user by the utility provider(s) 110. In an exemplary embodiment, the one or more energy pricing schemes may be communicated from the utility computing infrastructure 112 to the OEM central server 126 to be received by the pricing determinant module 404.

At block 506, the method 500 includes determining price points for the aggregated demand based on the one or more energy pricing schemes. The one or more energy pricing schemes may pertain to a plurality of price points associated with costs to purchase energy that may be associated with respective levels of charging demands that may occur or may be predicted to occur at various timeframes.

The plurality of price points may indicate a cost from the utility provider(s) 110 (a price per kilowatt-hour of energy (price per kWh)) that may be charged at various timeframes with respect to a cost to purchase energy for the one or more utility providers 110. The cost to purchase energy may include a dynamic value that may change over time based on a time of day, a season, a region, a time zone, etc. For example, each hour of a particular day may include a different cost to purchase energy based on one or more pricing schemes that are implemented by one or more natural resource providers, utility providers, and one or more levels of charging demands that may be influenced by the usage schedules implemented by the OEM(s) 124 among other factors (e.g., high expected traffic flow timeframes).

In another embodiment, the OEM central server 126 may propose a pricing scheme to the utility provider(s) 110 as processed by the policy application 128. The pricing scheme proposed by the OEM central server 126 may be processed by the policy application 128 based on the electronic processing completed by the components of the OEM central server 126 and communication of the OEM charging policy option from the OEM central server 126.

In an additional embodiment, the utility provider(s) 110 may communicate an incentive pricing scheme that is stored on the utility computing infrastructure 112 and may be communicated to the OEM central server 126 to thereby provide an incentive to the OEM(s) 124 to modify one or more demand based charging schedules to charge the EV(s) 118 at one or more timeframes that may result in the lowering of the cost to purchase energy to keep up with the charging schedule demand. Accordingly, the incentive scheme may be analyzed by the policy application 128 to determine one or more monetary incentives that may be provided to the OEM(s) 124 or the user to lower the demand on the utility provider(s) 110.

At block 508, the method 500 includes the policy determinant module 406 generating a usage schedule based on the aggregated demand and the price points. The usage schedule includes a schedule to provide energy to at least one energy consuming device of the plurality of energy consuming devices 106. As an illustrative example, the pricing determinant module 404 may evaluate the price points and group them into respective energy production cost timeframes that indicate particular pricing levels that are associated to the aggregated demand for particular timeframes. The pricing determinant module 404 may thereby determine one or more low, moderate, and high energy production cost timeframes that represent particular price points to produce energy for the utility provider(s) 110 at one or more points in time to thereby fulfill charging demands based on the usage schedule(s).

Suppose that the demand determinant module 402 receives an energy pricing scheme, and the pricing determinant module 404 determines that a first price point caps energy consumption at a first consumption level to receive a preferred rate from the utility provider(s) 110. Based on the aggregate demand, the demand determinant module 402 determines that the mini-grid 102 is expected to consume at a second consumption level higher that the first consumption level at a first time.

The usage schedule provides timeframes for delivering energy to at least one energy consuming device of the plurality of energy consuming devices 106. For example, suppose that the first energy consuming device 114 is a refrigerator and the second energy consuming device 116 is an air conditioner, and providing the first energy consuming device 114, the second energy consuming device 116 and one or more electric vehicles (EVs) 118 causes the mini-grid 102 to consume at a second consumption level at a first time. The usage schedule may indicate one or more devices of the plurality of energy consuming devices 106 that should receive energy, be prevented from receiving energy, and/or during which timeframes the one or more devices of the plurality of energy consuming devices 106 should receive or be prevented from receiving energy. For example, the usage schedule may indicate the second energy consuming device 116 should be turned off from the first time to a second time, later than the first time, or that the one or more electric vehicles (EVs) 118 should be charged at a second time. Accordingly, the usage schedule identifies which devices to charge during timeframes to satisfy the first consumption level and receive the preferred rate from the utility provider(s) 110.

At block 510, the method 500 includes transmitting a notification to the aggregator 104 for the least one energy consuming device based on the usage schedule. The policy implementation module 408 may utilize the communication interface 310 to communicate with the aggregator 104. The notification may include a command that causes the least one energy consuming device of the plurality of energy consuming devices 106 to be charged or stop charging. For example, the usage schedule may be utilized to charge the EV(s) 118 at one or more points in time based on an aggregated demand for charging to account for the cost to purchase energy. Accordingly, the usage schedule may modify the demand of the mini-grid such that the EV(s) 118 may be scheduled to be charged during a period(s) of time that includes a low cost to produce energy for the one or more utility providers 110. Accordingly, usage schedule may include the scheduling of EV(s) 118 to be charged during one or more low energy cost timeframes, wherein the cost to produce energy for the utility provider(s) 110 falls into a low percentage of a distribution of price points within a predetermined period of time.

The notification may also communicate with other power system participants, such as a user, the one or more utility providers 110, the OEM 124, and/or the third-party 134. For example, the user may receive a notification to a portable device of the user to alert the user to any modifications to power consumption in the usage schedule. In some embodiments, the user may have the opportunity to accept, modify, or reject the usage schedule or portions of the usage schedule. For example, the user may be able to accept the second energy consuming device 116 being turned off from the first time to a second time or reject the electric vehicles (EVs) 118 being charged at a second time. The user may also be able to modify the usage schedule, for example, causing the electric vehicles (EVs) 118 being charged at a third time.

The notification may also communicate with utility computing infrastructure 112 to communicate data that pertains to financial transaction account information (e.g., deposit account number) that may be utilized by the utility provider(s) 110 to facilitate payment of the incentive fee from the utility provider(s) 110 based on the usage schedule(s). Accordingly, the policy implementation module 408 may facilitate the remittance of the incentive fee.

In an exemplary embodiment, the policy implementation module 408 may utilize the communication interface 310 to communicate with the EV(s) 118, the charging station(s) 138, and/or the charging link(s) 140 to be operably controlled to implement scheduled charging of the EV(s) 118 from the charging station(s) 138 based on the usage schedule(s) as modified by the policy application 128. Therefore, the policy application 128 communicates with each of the power system participants. For example, the policy application takes in different information from a mini-grid 102, such as the aggregated demand, the utility provider(s) 110, such as the pricing scheme, and may transmit notifications to the aggregator 104, such as command to charge a device of the plurality of energy consuming devices 106. Because each of the power system participants communicate using different protocols, the policy application 128 resolves the different protocols allowing for greater harmonization between the power system participants. The user can leverage the harmonization to balance the energy consumption and generation of the plurality of energy consuming devices 106 and the DERs 108 to receive better rates from utility provider(s) 110.

FIG. 6 is a process flow diagram of another method for control of a mini-grid according to an exemplary embodiment. FIG. 6 will be described with reference to the components of FIGS. 1-5, though it is to be appreciated that the method 600 of FIG. 6 may be used with other system and/or components. For simplicity, the method 600 will be described as a sequence of elements, but it is understood that the elements of the method 500 can be organized into different architectures, blocks, stages, and/or processes. The method 600 includes steps described with respect to the method 500 described with respect to FIG. 5. These steps of FIG. 6 operate in a similar manner as described with respect to their counterparts in FIG. 5.

The method 600 may begin at 502, the method 500 includes receiving an aggregated demand for a mini-grid 102 from an aggregator 104 based on electrical data. In some embodiments, the demand determinant module 402 receives electrical data from the aggregator 104 as the aggregated demand and calculates a calculated demand from the aggregated demand. In some embodiments, the demand determinant module 402 may resolve a number of protocols to facilitate communication between the policy application 128 and the power system participants (e.g. mini-grid 102, the one or more utility providers 110, the OEM 124, and the third party 134, as well as various remote devices (e.g., databases, web servers, remote servers, application servers, intermediary servers, client machines, other portable devices).

At block 602, the method 600 includes the demand determinant module 402 determining one or more priority scores for at least one energy consuming device of the energy consuming devices 106. The priority score determines the relative charging priority of devices within the mini-grid 102. Returning to the example from above, suppose that the first energy consuming device 114 is a refrigerator and the second energy consuming device 116 is an air conditioner. Based on the electrical data, the demand determinant module 402 may determine from the electrical data that the first energy consuming device 114 runs consistently while the second energy consuming device 116 runs periodically. Accordingly, the first energy consuming device 114 may have a higher priority score that the second energy consuming device 116. In another embodiment, the demand determinant module 402 may determine that first energy consuming device 114 is a refrigerator and the second energy consuming device 116 is an air conditioner based on device type information. A food preservation device may be prioritized over an environmental device. Accordingly, the first energy consuming device 114 may have a higher priority score that the second energy consuming device 116. In this manner, the demand determinant module 402 may determine the priority scores based on the type of device, power, average usage, consumption, load patterns, state of charge data, charge parameters, charging data and feedback, vehicle system data, historical usage data, operating and/or charging schedules, etc. Additionally, the demand determinant module 402 may determine the priority score of devices of the mini-grid 102 based on a rule set. The rule set includes one or more rules such as an energy consuming device that runs consistently is prioritized over another energy consuming device that runs periodically or a food preservation device may be prioritized over an environmental device.

At block 504, the method 600 includes receiving one or more energy pricing schemes from one or more utility providers. At block 506, the method 600 includes determining price points for the aggregated demand based on the one or more energy pricing schemes. Blocks 504 and 506 operate in a similar manner as discussed above with respect to FIG. 5.

At block 604, the method 600 includes the policy determinant module 406 generating a usage schedule based on the price points and the priority scores. For example, suppose that EV(s) require a charge. The policy determinant module 406 may use the price points and the priority scores to determine when the EV(s) 118 can be economically charged. Continuing the example from above, the usage schedule the charging of the first energy consuming device 114, the second energy consuming device 116, and the EV(s) 118. Suppose the price points indicate that the rate at night may be lower at night and that the first energy consuming device 114 has a higher priority score that the second energy consuming device 116. Accordingly, the usage schedule may define that the second energy consuming device 116 can be provided less energy at night. Accordingly, the second energy consuming device 116 be scheduled to run less often and at night, but the first energy consuming device 114 is scheduled to run continuously in the usage schedule.

At block 510, the method 600 includes transmitting a notification to the aggregator 104 for the least one energy consuming device based on the usage schedule. For example, the notification may be a message to the aggregator 104 to cause the devices of the mini-grid 102 to comply with the usage schedule. In some embodiments, the notification may be sent to a user to offer the user the user schedule so that the user can operate the devices in the mini-grid in accordance with the usages schedule. In this manner, the usage schedule allows the user to operate devices of the mini-grid 102 while accounting for the priorities of the user.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to. Similarly, when two items are described, those two items may be referred to as a first item or a second item to distinguish the two items without implying a temporal aspect, a spatial aspect, an ordering, etc.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for controlling a mini-grid, comprising:
receiving an aggregated demand for a mini-grid from an aggregator based on electrical data, wherein the mini-grid includes a plurality of energy consuming devices and at least one distributed energy resource associated with a user;
receiving one or more energy pricing schemes from one or more utility providers;
determining price points for the aggregated demand based on the one or more energy pricing schemes;
generating a usage schedule based on the aggregated demand and the price points, wherein the usage schedule includes a schedule to provide energy to at least one energy consuming device of the plurality of energy consuming devices; and
transmitting a notification to the aggregator for at least one energy consuming device of the plurality of energy consuming devices based on the usage schedule.

2. The computer-implemented method of claim 1, wherein the at least one energy consuming device is an electric vehicle, and wherein the electrical data includes receiving state of charge data and charging data for the electric vehicle.

3. The computer-implemented method of claim 2, wherein determining the usage schedule includes analyzing the state of charge data and the electrical data, and wherein the usage schedule is based on the aggregated demand for charging the electric vehicle.

4. The computer-implemented method of claim 1, wherein the price points are evaluated to determine energy production cost timeframes that are associated with a cost to produce energy for the at least one utility provider.

5. The computer-implemented method of claim 4, wherein the usage schedule causes an original equipment manufacturer (OEM) to lower demand for providing energy during a high energy cost.

6. The computer-implemented method of claim 1, further comprising:
determining an incentive fee that is to be remitted by the at least one utility provider to the user based on the one or more energy pricing schemes.

7. The computer-implemented method of claim 1, wherein the notification causes the aggregator to communicate with the at least one distributed energy resource to provide energy to the at least one energy consuming device.

8. A system for controlling a mini-grid, comprising:
a memory storing instructions when executed by a processor cause the processor to:
receive an aggregated demand for a mini-grid from an aggregator based on electrical data, wherein the mini-grid includes a plurality of energy consuming devices and at least one distributed energy resource associated with a user, and wherein the plurality of energy consuming devices includes at least one electric vehicle;
receive one or more energy pricing schemes from one or more utility providers;
determine price points for the aggregated demand based on the one or more energy pricing schemes;
generate a usage schedule based on the aggregated demand and the price points, wherein the usage schedule includes a schedule to charge the at least one electric vehicle; and
transmit a notification to the aggregator for the at least one electric vehicle based on the usage schedule.

9. The system of claim 8, wherein the electrical data includes receiving state of charge data and charging data for the at least one electric vehicle.

10. The system of claim 9, wherein determining the usage schedule includes analyzing the state of charge data and the charging data, and wherein the usage schedule is based on the aggregated demand for charging the at least one electric vehicle.

11. The system of claim 8, wherein the price points are evaluated to determine energy cost timeframes that are associated with a cost to purchase energy from at least one utility provider.

12. The system of claim 11, wherein the usage schedule enables an original equipment manufacturer (OEM) to lower demand for charging during a high energy cost timeframe.

13. The system of claim 8, the memory storing instructions when executed by a processor further cause the processor to determine an incentive fee that is to be remitted by at least one utility provider to the user based on the one or more energy pricing schemes.

14. The system of claim 8, wherein the notification causes the aggregator to communicate with at least one charging station, or at least one charging link, to be operably controlled to implement scheduled charging of the at least one electric vehicle based on the usage schedule.

15. A computer-implemented method for controlling a mini-grid, comprising:
receiving an aggregated demand for a mini-grid from an aggregator based on electrical data, wherein the mini-grid includes a plurality of energy consuming devices and at least one distributed energy resource associated with a user, and wherein the plurality of energy consuming devices includes at least one electric vehicle;
receiving one or more energy pricing schemes from one or more utility providers;
determining price points for the aggregated demand based on the one or more energy pricing schemes;
generating a usage schedule based on the aggregated demand and the price points, wherein the usage schedule includes a schedule to charge the at least one electric vehicle; and
transmitting a notification to the aggregator for the at least one electric vehicle based on the usage schedule.

16. The computer-implemented method of claim 15, wherein the electrical data includes receiving state of charge data and charging data for the at least one electric vehicle, and wherein determining the usage schedule includes analyzing the state of charge data and the charging data, and wherein the usage schedule is based on the aggregated demand for charging the at least one electric vehicle.

17. The computer-implemented method of claim 15, wherein the price points are evaluated to determine energy production cost timeframes that are associated with a cost to produce energy for the at least one utility provider.

18. The computer-implemented method of claim 17, wherein the usage schedule enables an original equipment manufacturer (OEM) to lower demand for charging during a high energy cost timeframe.

19. The computer-implemented method of claim 15, further comprising:
determining an incentive fee that is to be remitted by at least one utility provider to the user based on the one or more energy pricing schemes.

20. The computer-implemented method of claim 15, wherein the notification causes the aggregator to communicate with at least one charging station, or at least one charging link, to be operably controlled to implement scheduled charging of the at least one electric vehicle based on the usage schedule.
